(19) United States
(12) Patent Application Publication
(10) Pub. No.: US 2013/0138580 A1
(43) Pub. Date: May 30, 2013

(54) METHODS AND SYSTEMS FOR PROVIDING SWAP INDICES

(71) Applicant: Barclays Capital Inc., New York, NY (US)

(72) Inventors: Lee Stephen Phillips, London (GB); Albert Desclee, London (GB)

(73) Assignee: BARCLAYS CAPITAL INC., New York, NY (US)

(21) Appl. No.: 13/750,440

(22) Filed: Jan. 25, 2013

Related U.S. Application Data
(63) Continuation of application No. 12/830,484, filed on Jul. 6, 2010, now abandoned.
Application No. 12/830,484 is a division of application No. 11/854,922, filed on Sep. 13, 2007, now abandoned.
(60) Provisional application No. 60/844,850, filed on Sep. 14, 2006.

(51) Int. Cl. G06Q 40/06

(52) U.S. Cl. CPC G06Q 40/06
USPC 705/36 R

(57) ABSTRACT

Zero-coupon swap indices are provided for tracking characteristics of nominal, inflation-linked liabilities and other aspects of swaps. A zero-coupon nominal swap index is based on a portfolio of assets consisting of a cash investment at a reference rate combined with a zero-coupon swap, where periodic payments can be exchanged for a single fixed cash flow at maturity. A zero-coupon inflation swap index is based on a portfolio of investments in a zero-coupon inflation swap, a zero-coupon nominal swap and cash invested at a reference rate. Periodic payments on the cash investment can be exchanged, in a zero-coupon nominal swap transaction, for a single fixed payment at maturity.

### PRIORITY APPLICATION

This application claims the benefit of U.S. Provisional Patent Application No. 60/844,850 filed Sep. 14, 2006, titled Swap Indices. The entire contents of that application are incorporated herein by reference.

### INTRODUCTION

A Swap Index is an index that represents performance of swaps, collectively, as a market sector. The term index is used herein to describe a portfolio, which can include swaps, or assets, commodities, securities, bonds, etc., that represent a particular market or a portion of a market. An index may be used to measure changes in an economy, portfolio, sector or other aspect of a market, and typically has a calculation methodology. A swap is an exchange of one type of asset for another, such as a derivative in which two parties (counterparties) agree to exchange one stream of cash flows for another stream. Such exchanged streams in a swap are called the legs of a swap. In general, the cash flows in the swap are calculated as a notional principal amount, (which is usually not exchanged between counterparties) and can be used to create unfunded exposures to an underlying asset, since counterparties can earn the profit or loss from movements in price without having to post the notional amount in cash or collateral. Common types of swaps include: interest rate swaps, currency swaps, credit swaps, commodity swaps and equity swaps.

Some swap indices are designed to track, for example, a portfolio of weighted returns of a plurality of swaps with varying maturities, e.g., 1 year, 2 years, etc. to 30 years. Examples of swap indices include: Composite Swap Indices, Bellwether Swaps and Mirror Swaps Indices. A Composite Swap Index may provide an equal weighted portfolio of several swaps with annual (or other period) maturities. A Bellwether Swap Index typically includes a swap with a maturity at a key-rate point. A Mirror Swap Index typically provides total returns of a portfolio of swaps constructed to match key-rate exposure of other indices (e.g., Aggregate, Government/Credit, Credit, Agency, MBS, ABS or CMBS Investment Grade). For example, a mirror swap index may be provided for a bond market, or a portion of a bond market, such as a fixed coupon bond.

Some types of liability patterns, such as pension liability cash flows are difficult to measure using conventional indices. In general, pension liability cash flows are typically long-dated and can be expressed in nominal terms or indexed to a measure of inflation, according to the nature of the underlying liabilities. Traditional bond indices have not proven to be suitable to represent such liability patterns. The indices described herein address these and other limitations of conventional indices.

In one embodiment of the invention, a method is provided that comprises: constructing a portfolio comprising a cash investment at a reference rate and a zero-coupon swap; exchanging a periodic payment on the cash investment at the reference rate for a single fixed cash flow at a maturity date, wherein an amount of the cash investment at the reference rate relates to a floating leg of the zero-coupon swap; and providing an index based on the portfolio, wherein a total return of the index indicates a return of a zero-coupon bond at the maturity date, wherein a price of the zero-coupon bond is based on the zero-coupon swap.

In another embodiment of the invention, a method is provided that comprises: constructing a portfolio comprising an investment in a zero-coupon inflation swap, an investment in a zero-coupon nominal swap, and a cash investment at a reference rate; exchanging a periodic payment on the cash investment at the reference rate for a single inflation-indexed cash flow at a maturity date, wherein an amount of the cash investment at the reference rate relates to a floating leg of the zero-coupon nominal swap; and providing an index based on the portfolio, wherein a total return of the index indicates a return of a zero-coupon inflation bond at the maturity date, wherein a price of the zero-coupon inflation bond is based on the zero-coupon inflation swap and the zero-coupon nominal swap.

In another embodiment of the invention, an index is provided that comprises: a portfolio comprising a cash investment at a reference rate and a zero-coupon swap, wherein a periodic payment on the cash investment at the reference rate is exchanged for a single fixed cash flow at a maturity date, and an amount of the cash investment at the reference rate relates to a floating leg of the zero-coupon swap; a price of the cash investment provided by a swap curve; and a total return of the portfolio based on the price of the cash investment and a marked-to-market calculation of the zero-coupon swap, wherein the index is provided based on the portfolio, and a total return of the index indicates a return of a zero-coupon bond at the maturity date, the zero-coupon bond having a price based on the zero-coupon swap.

In another embodiment of the invention, an index is provided that comprises: a portfolio comprising an investment in a zero-coupon inflation swap, an investment in a zero-coupon nominal swap, and a cash investment at a reference rate; a periodic payment on the cash investment at the reference rate exchanged for a single inflation-indexed cash flow at a maturity date, wherein an amount of the cash investment at the reference rate relates to a floating leg of the zero-coupon nominal swap; a price of the portfolio provided by a swap curve; and a total return of the portfolio based on a price of the cash investment and a marked-to-market calculation of the zero-coupon inflation swap and the zero-coupon nominal swap; wherein: the index is provided based on the portfolio, a total return of the index indicates a return of a zero-coupon inflation bond at the maturity date, and a price of the zero-coupon inflation bond is based on the zero-coupon inflation swap and the zero-coupon nominal swap.

### BRIEF DESCRIPTION OF THE FIGURES

FIGS. 1A-1B depict cash flows for an investment for a zero-coupon nominal swap index according to an embodiment of the invention;

FIG. 2 depicts a screenshot showing returns for a zero-coupon nominal swap index according to an embodiment of the invention;

FIG. 3 depicts a screenshot of data relating to a zero-coupon nominal swap index according to an embodiment of the invention;

FIGS. 4A-4B depict cash flows for an investment for a zero-coupon inflation swap index according to an embodiment of the invention;

FIG. 5 depicts a screenshot showing returns for a zero-coupon inflation swap index according to an embodiment of the invention; and

FIG. 6 depicts a breakeven inflation curve according to an embodiment of the invention.

### DETAILED DESCRIPTION

Embodiments of the invention provide a swap index, more specifically, a zero-coupon swap index that provides, among other advantages, the ability to track characteristics of nominal, inflation-linked liabilities and other aspects of swaps. Several types of swap indices are described herein, including a zero-coupon inflation swap index and a zero-coupon nominal swap index. Although the examples described herein relate to zero-coupon instruments and inflation/nominal features, it should be understood that the examples, descriptions and calculations described herein may be applied to other types of indices, assets, and financial instruments as will be recognized by one of skill in the art.

A zero-coupon bond is a bond that typically does not pay interest during the life of the bond. A zero-coupon bond is purchased at a discount from its face value, which is the value of the bond at maturity or when it comes due. Thus, when a zero-coupon bond matures, the investor receives the face value, which is one lump sum equal to the initial investment plus interest that has accrued. Maturity dates on zero-coupon bonds are usually long-term, e.g., more than ten years. Since zero-coupon bonds pay no interest until maturity, their prices can fluctuate more than other types of bonds of similar maturities in the secondary market.

There are various applications in which swap indices are useful, such as for providing a realistic valuation of liabilities against which to assess performance of insurance investments, pension funds or other funds. Other applications include, for combined nominal and inflation swap indices, creating liability benchmarks which closely track inflation-linked and fixed nominal characteristics of future cash streams. Other applications may also be provided for swap indices.

In embodiments of the invention, a zero-coupon inflation and a zero-coupon nominal swap index typically represent funded investments in a hypothetical single cash flow, or zero-coupon bond, which allow for a precise representation of liability cash flows, either nominal or inflation-linked. Such swap indices can cover a broad range of maturities, which may be unavailable in a cash bond market or other markets. Such indices also can provide references for total return swaps and hedging solutions linked to liability benchmarks. The indices can be replicated with a combination of cash deposit, nominal and inflation-linked swaps and provide a complement to other types of swap indices, e.g., bellwether and mirror swap indices.

In general, zero-coupon inflation and nominal swap indices (each further described herein) are designed to represent a fully funded investment in a hypothetical zero-coupon bond. Such indices can be provided as rolling maturity swap indices which is particularly suitable for open funds where liabilities are extending. Preferably such rolling maturity swap indices are rebalanced at every month (or other period) end and the maturity date for the index investments shifts forward by one month (or some other period that may be the same as that used for rebalancing). Other swap indices can be provided with fixed maturity dates. Such fixed maturity date swap indices are especially suitable for closed funds, which may have liabilities that amortize over time. Typically a fixed maturity date swap index is static and may not be rebalanced after inception. This means that the fixed maturity date swap index maturity will decrease through time to match the characteristics of a closed fund.

Zero-Coupon Nominal Swap Index

A zero-coupon nominal swap index typically represents the performance of single cash flows priced in a swap curve. In some embodiments, a zero-coupon nominal swap index is defined as a hypothetical zero-coupon bond priced in a swap curve. A swap curve is a graph that plots or otherwise represents one or more swap rates against a maturity or length of the one or more swaps. Since swap markets have relatively high liquidity, swap curves can be used as a benchmark for interest rates on assets which have a maturity that exceeds a year.

A replicating portfolio of assets which produces the performance of a zero-coupon nominal swap index typically consists of a cash investment at LIBOR (EURIBOR, or other reference rate can also be used) combined with a zero-coupon swap, where periodic LIBOR payments can be exchanged for a single fixed cash flow at maturity. (LIBOR stands for the London Interbank Offered Rate which is a daily reference rate based on the interest rates at which banks offer to lend unsecured funds to other banks in the London wholesale money market (or interbank market)). At inception of the index, the size of a cash investment (for the portfolio) is equal to the present value of the fixed payment at a zero-coupon swap rate of an appropriate maturity. Therefore, the periodic interest payments on that cash investment can be exchanged, in a zero-coupon swap transaction, against a single fixed payment at maturity. In typical zcro-coupon nominal swap indices, total returns for the index are equivalent to the return of a zero-coupon bond priced in a swap curve, and periodic index returns reflect the change in present value of a fully funded investment in a zero-coupon bond. Generally, a zero-coupon nominal swap index is useful for benchmarking nominal-indexed liabilities.

One example of a total return calculation for a fixed term zero swap index with a maturity date of Dec. 31, 2011 at two different dates is provided in Table 1:

TABLE 1
Example Return Calculation - Fixed Term Zero
Swap Index Dec. 31, 2011

| Date | Remaining Life | Yield (Semi-Annual) | Price | Return |
|---|---|---|---|---|
| 05312006 | 5.5833 | 3.902 | 80.5922 | −0.506% |
| 06302006 | 5.5 | 4.056 | 80.1844 | |

The formulas preferably used to calculate the total return for this example are:

$$\begin{matrix}Price \text{:} {P}_{t = 06302006} = \frac{100}{{( 1 + \frac{4.056}{200} )}^{{2}^{*} 5.5}} \\ = 80.1844\end{matrix}$$

$$\begin{matrix}Return \text{:} {R}_{t , t + 1} = \frac{{P}_{t + 1}}{{P}_{t}} - 1 \\ = \frac{80.1844}{80.5922} - 1 \\ = - 0.506 \%\end{matrix}$$

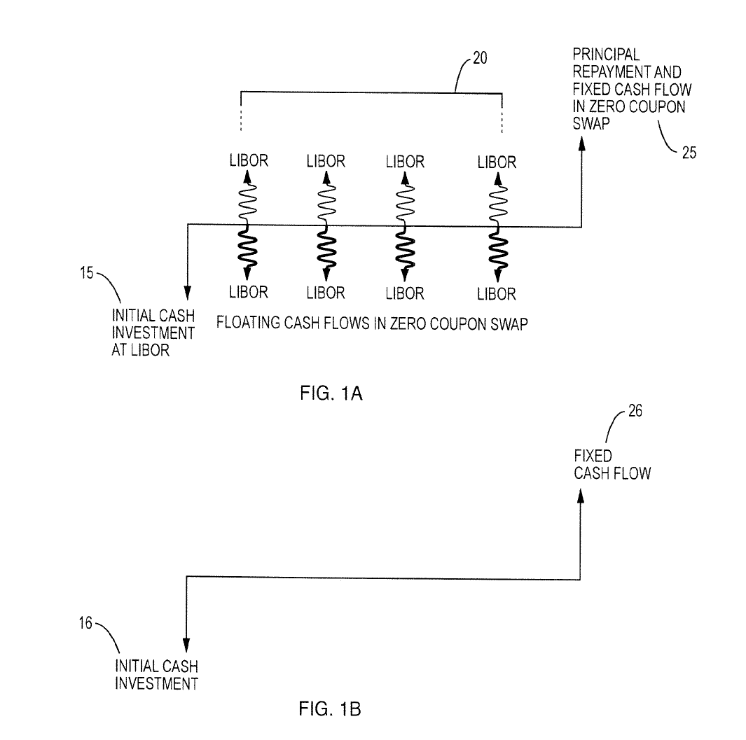

A zero-coupon nominal swap index can be replicated using a cash deposit and a zero-coupon nominal swap. Referring to FIGS. 1A and 1B, a zero-coupon nominal swap index typically includes two positions, a cash investment at LIBOR (15) and a zero-coupon nominal swap where a stream of LIBOR payments (20) is exchanged for a single nominal cash flow at maturity (25). FIG. 1B shows the combined positions of FIG. 1A to provide an initial cash investment 16 and a fixed cash flow 26 which represent a zero-coupon bond.

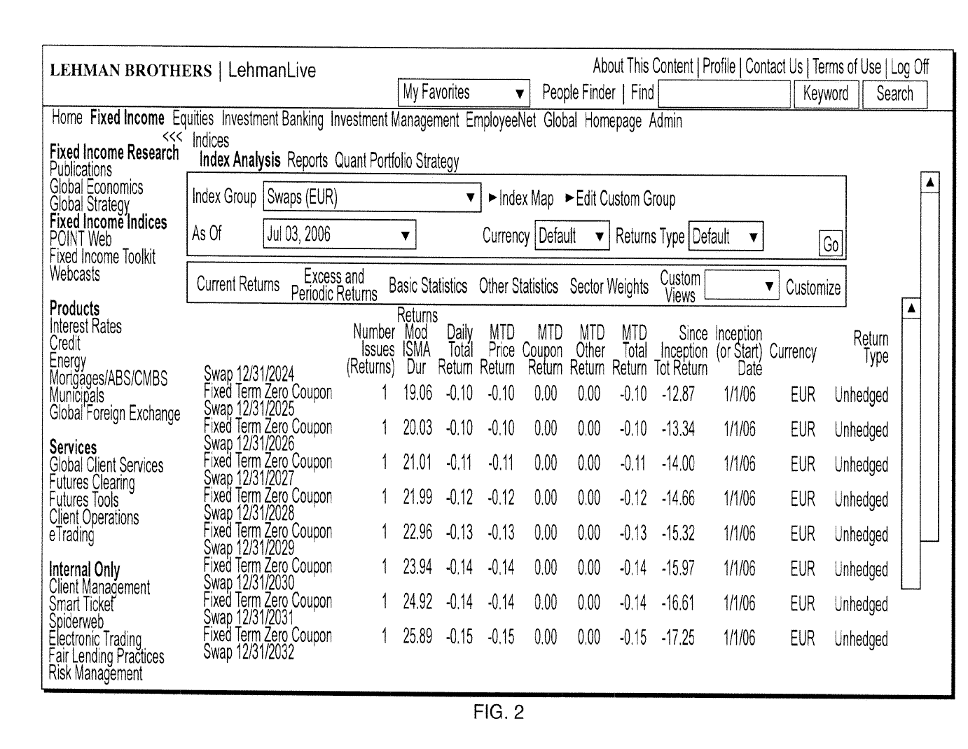

FIG. 2 depicts a screenshot showing exemplary current and historical data for a zero-coupon nominal swap. As shown, benchmarks and other aspects of an index can be customized.

A swap index can cover a broad range of maturities in major markets. Rolling maturity swap indices are particular suitable for open funds where liabilities are extending periodically. Such rolling maturity indices are typically rebalanced at every month (or other period) end and the maturity date shifts forward by one month (or corresponding period). A fixed maturity swap index is suitable for closed funds (i.e., a fund that is, temporarily or permanently, no longer issuing new shares or that is no longer accepting investments from new investors) which amortize over time. Such indices are typically static and are not rebalanced after inception. This means that the index maturity will decrease through time to match the characteristics of a closed fund. Maturity coverage can extend for a long term, such as 50 years. Such terms are meant to be exemplary and longer or shorter maturity terms can also be used.

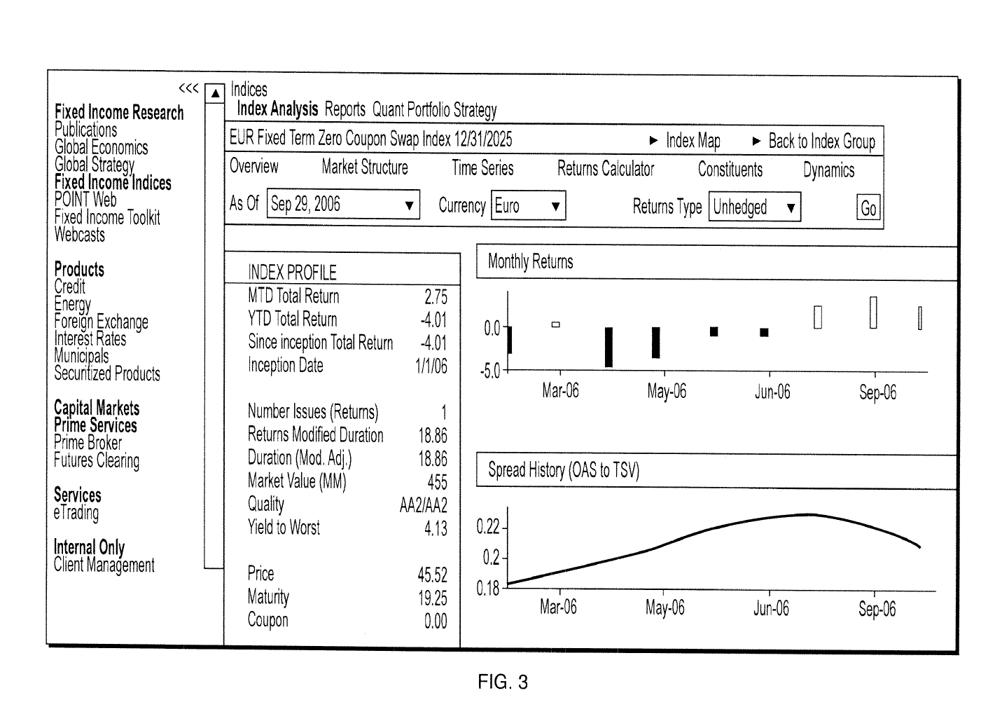

As mentioned previously, zero-coupon nominal swap indices can be used to track the present value of nominal liabilities (which are liabilities consisting of known future payments as opposed to liabilities consisting of future payments linked to changes in an inflation index or another fluctuating quantity) For example, a portfolio may be assembled to neutralize a single [symbol] 100M nominal liability maturing in December 2025. Such portfolio may be assembled by choosing a zero-coupon fixed maturity December 2025 swap index as a benchmark. An example of such an exemplary index is illustrated in the screenshot of FIG. 3. As shown in FIG. 3, at the end of September 2006, a present value for such liability is [symbol] 45.52M according to an (index price) multiplied by a (projected liability amount).

Zero-Coupon Inflation Swap Index

A zero-coupon inflation swap index is provided using a real (also called inflation-linked, or inflation-indexed) cash flow priced in a real rates curve, as may be provided in an inflation swap market. A real rates curve is a graph often used to represent the rates of interest in excess of the rates of inflation and depicts, generally, a real yield on an inflation-linked bond.

The cash flow at maturity of investments used in the swap index may be estimated using growth in an inflation index between the time of investment and a maturity date. The present value of the investments is provided as a function of a breakeven rate of inflation and a nominal interest rate priced off the nominal and inflation swap curves. Such inflation swap indices can be used for benchmarking inflation-indexed liabilities, such as pension liabilities or other liabilities.

A return for a zero-coupon inflation swap index can be used to represent growth in inflation between a time of an investment and a maturity date of the investment or index. In general, a zero-coupon inflation swap index is a hypothetical real cash flow priced in a swap curve. Replicating a portfolio for a zero-coupon inflation swap may be performed using investments in a zero-coupon inflation swap, a zero-coupon nominal swap and cash invested at LIBOR. The invested amount of cash is equal to the present value of the inflation-indexed payment at a real rate of the appropriate maturity. Therefore, the periodic interest payments on that cash investment can be exchanged, in a zero-coupon nominal swap transaction, for a single fixed payment at maturity. The fixed payment at maturity can in turn be exchanged for an inflation-protected payment at maturity in a zero-coupon inflation swap transaction. The result is an index that reflects the return of a zero-coupon inflation bond priced using an inflation swap curve.

The zero-coupon inflation swap index return at maturity represents a growth in the inflation index between the time of investment I(0) and a maturity date I(T), with a small lag that reflects the convention in the inflation-linked swap markets. The present value of such inflation linked cash flow at intermediate maturities is function of: an observed, realized rate of inflation, and a real rate of interest. Zero-coupon inflation swap indices are also available in both fixed dates format and rolling maturities format, as previously described with reference to zero-coupon nominal swap indices. The zero-coupon nominal and inflation swap index markets provide market pricing for the nominal and breakeven curves.

A zero-coupon inflation swap index is provided as a single inflation-protected cash flow. A fixed leg of the inflation swap, F, is defined as the breakeven inflation rate, b, compounded to maturity T. This is the projected real cash flow at maturity of the swap. The breakeven rate is provided by the inflation swap market. The fixed leg of the inflation swap F may be calculated using the formula: F=(1+b)^{T}. The present value P of the future cash flow, discounted at a nominal rate n, can be calculated using the formula:

$$\begin{matrix}P = \frac{F}{{( 1 + n )}^{T}} \\ = \frac{{( 1 + b )}^{T}}{{( 1 + n )}^{T}} \\ = {D}_{r} ( 0 , T ) .\end{matrix}$$

The index price can thus be represented as a real discount factor: Dᵣ(0,T). Since breakeven rates are typically lower than nominal rates, and real rates are positive, the index price P (which may also represent an initial cash investment in a replicating portfolio) is typically smaller than the inflation swap notional F in the hedging portfolio. Marking the index to market reflects changes in breakeven and nominal rates as well as realized inflation. If seasonality effects are ignored, an index price after one period can be expressed as a function of the realized growth in the inflation index and real discount factors:

$$P ( t ) = \frac{I ( t )}{I ( 0 )} \times {D}_{r} ( t , T ) .$$

A return may be calculated using the formula:

$$\begin{matrix}R = \frac{P ( t )}{P ( 0 )} - 1 \\ = \frac{I ( t )}{I ( 0 )} \times \frac{{D}_{r} ( t , T )}{{D}_{r} ( 0 , T )} - 1 \\ = \frac{I ( t )}{I ( 0 )} \times \frac{{( 1 + {b}_{t , T} )}^{T - 1}}{{( 1 + {b}_{0 , T} )}^{T}} \times \frac{{( 1 + {n}_{0 , T} )}^{T}}{{( 1 + {n}_{t , T} )}^{T - 1}} - 1.\end{matrix}$$

Certain market variables can affect inflation swap index returns, as described in Table 2:

TABLE 2

| Market variable | Notation | Effect on mark-to-market |
|---|---|---|
| Value of inflation | I(t) | Positive if I(t)/I(0) > b_{0,T} (i.e. inflation |
| index | | increased more than suggested initially by |
| | | the breakeven rate) |
| Breakeven rate to | b_{t,T} | Positive if breakeven rate increases |
| maturity | | (b_{t,T} > b_{0,T}) |
| Nominal rate | n_{t,T} | Positive if nominal rate decreases |
| | | (n_{t,T} < n_{0,T}) |

Preferably, a zero-coupon inflation swap index follows the inflation swap market conventions when accounting for the realized inflation, (e.g. a two-month lag for the UK RPI (Retail Price Index), a three-month lag for [symbol] -HICPxT, etc.) ( [symbol] -HICPxT is a Euro-based inflation index: Harmonised Index of Consumer Prices Excluding Tobacco.)

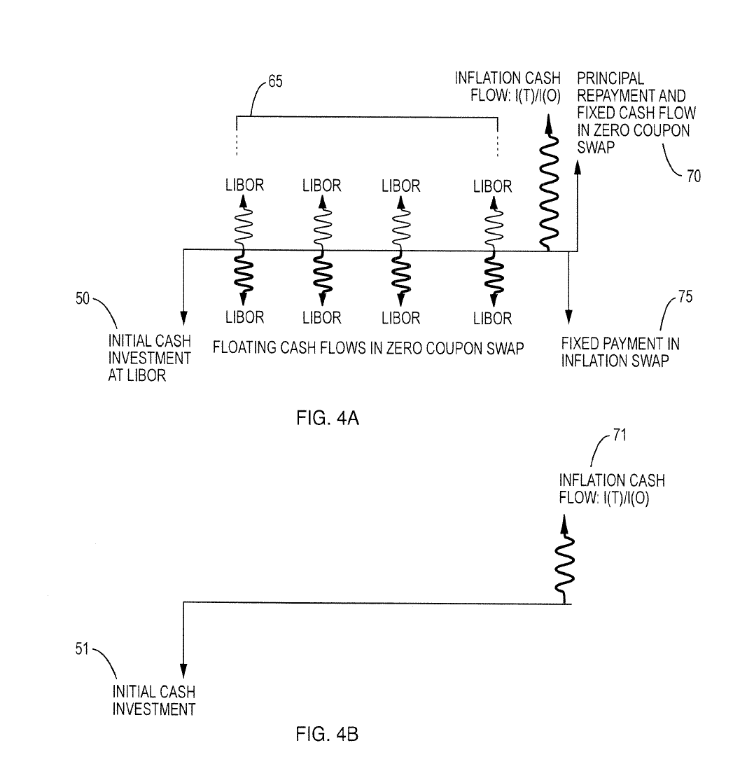

Zero-coupon inflation swap indices can be replicated with zero-coupon nominal and inflation swaps and include, as shown in FIG. 4A, three positions: a cash investment at LIBOR (50), a zero-coupon nominal swap (70), where a stream of LIBOR payments (65) is exchanged for a single nominal cash flow at maturity, and a zero-coupon inflation swap (75), where a single nominal cash flow is exchanged at maturity for an inflation-protected cash flow. The three positions combine in FIG. 4B to represent an inflation protected zero-coupon bond which has an initial cash investment (51) and inflation cash flow (71): I(T)/I(0). The performance of the index at maturity is largely a function of inflation.

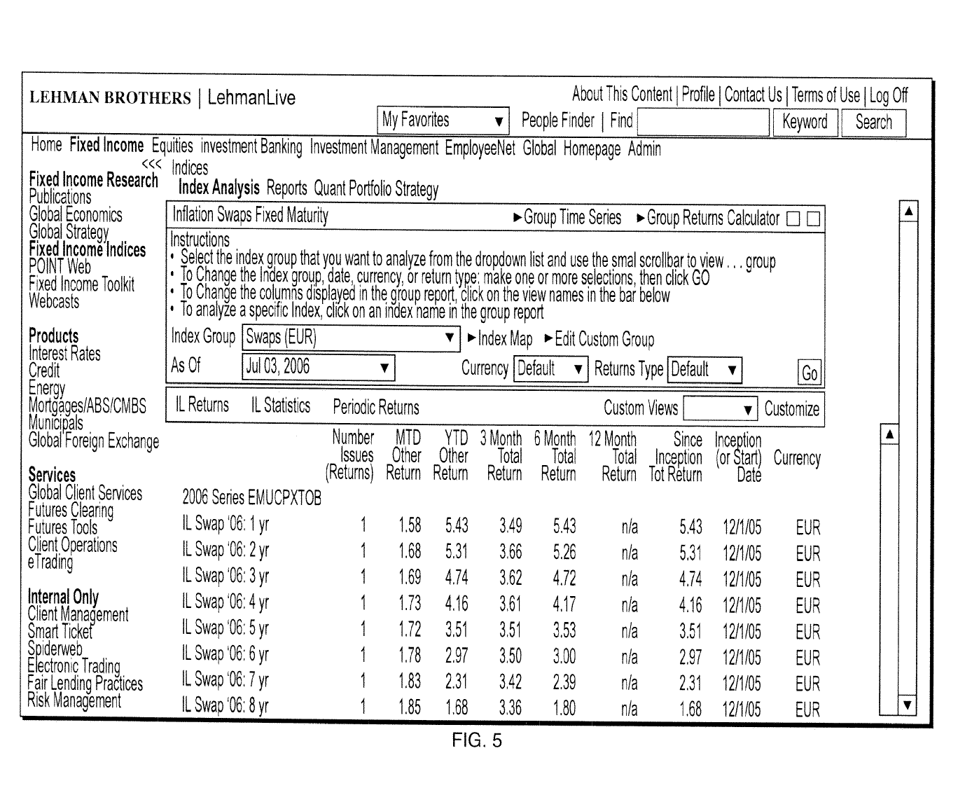

Current and historical return and statistical data for a zero-coupon inflation swap index can be customized, e.g., as shown in the screenshot depicted in FIG. 5.

As mentioned above, zero-coupon inflation swap indices can be used to track the value of inflation-linked liabilities. For example, an inflation-protected payment of [symbol] 100M (un-inflated projected amount) must be made in December 2025. To establish an index for comparison, a fixed maturity date December 2025 is used at a [symbol] -HICPxT swap index as a benchmark. To provide the replicated portfolio, the index invests at December 2005 to immunize the 20 year cash flow. On 31 Dec. 2005, the present value of this inflation-linked cash flow is the index price multiplied by a notional which equals [symbol] 73.581M, preferably using the following calculations:

Projected inflation growth is discounted at a relevant nominal interest rate=Real discount factor Dᵣ(0,T).

$$\begin{matrix}{P}_{Dec 05} = \frac{{( 1 + b )}^{T}}{{( 1 + n )}^{T}} \\ = {D}_{r} ( 0 , T ) \approx \frac{{( 1 + 0.022 )}^{20}}{{( 1 + 0.038 )}^{20}} \\ = 0.73581\end{matrix}$$

Note that the reference and projected inflation indices at maturity are published, such that a reference inflation index for December 2005 is I(0)=100.6734 and a projected inflation index for reference in December 2025 is I(T)=156.2485≈100.6734·(1+0.02222)²⁰. Thus, projected inflated liability cash flow is [symbol] 100M×(156.2485/100.6734)= [symbol] 155.203M.

On 30 Sep. 2006, the inflation-protected investment can be marked-to-market using a new nominal interest rate: 4.17% (annually compounded) and a new projected reference inflation index for December 2025=156.841 which reflects changes in a breakeven inflation curve (including seasonality adjustments) and realized inflation between December 2005 and September 2006 (using an appropriate lag). Using the new rates and inflation index, the new index price would be:

$$\begin{matrix}{P}_{Sep 06} = \frac{I ( T )}{I ( 0 )} \cdot {D}_{n} ( t , T ) \approx \frac{156.841 / 100.6734}{{( 1 + 0.0417 )}^{19.25}} \\ = 0.70894 .\end{matrix}$$

The new index return would be:

$$\begin{matrix}{R}_{t , t + 1} = \frac{{P}_{t + 1}}{{P}_{t}} - 1 \\ = \frac{70.894}{73.581} - 1 \\ = - 3.653 \% .\end{matrix}$$

If a sponsor provides a projected inflated cash flow, then the amount to invest in December 2005 to protect a [symbol] 100M anticipated inflated cash flow in December 2025 is [symbol] 47.41M, which is the present value of [symbol] 100M discounted at a nominal rate (3.799% for 20 years).

Seasonality

Another aspect of zero-coupon inflation swap indices to consider is the potential influence of seasonal factors on inflation. For example, January and summer sales typically have a dampening effect on inflation. Using regression analysis, seasonal factors for HICPxT can be estimated, e.g., as shown in Table 3:

TABLE 3

| Month | seasonal | std. errors | significant |
|---|---|---|---|
| January | −2.37% | 0.50% | Yes |
| February | 2.22% | 0.48% | Yes |
| March | 2.32% | 0.48% | Yes |
| April | 1.30% | 0.48% | Yes |
| May | 0.55% | 0.48% | No |
| June | −0.80% | 0.48% | No |
| July | −1.86% | 0.48% | Yes |
| August | −0.95% | 0.48% | No |
| September | 0.30% | 0.48% | No |
| October | −0.65% | 0.48% | No |
| November | −1.45% | 0.48% | Yes |
| December | 1.39% | 0.48% | Yes |

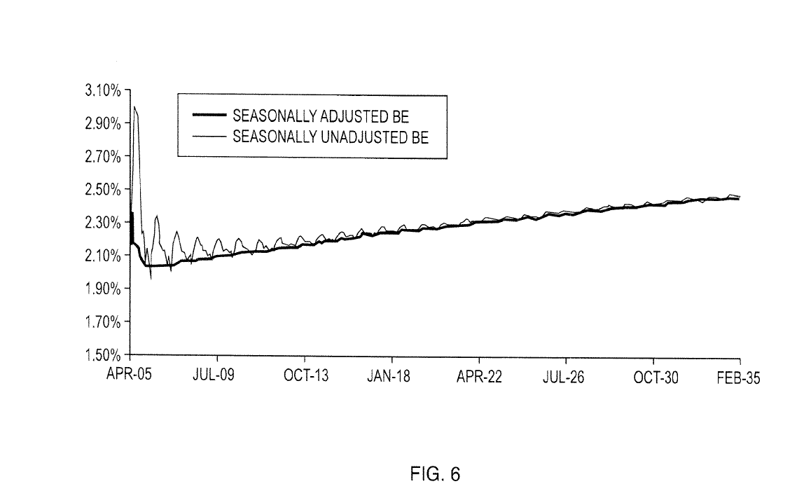

The net effect of seasonal factors across a full year is zero since they represent local variations around the annual average inflation rate. In the presence of seasonal factors, linear interpolations between various breakeven yearly quotes may not be appropriate. The effect of seasonality should be incorporated when determining a breakeven curve for re-pricing inflation swaps between annual points. An exemplary breakeven curve is depicted in FIG. 6.

Seasonality adjustments can be important because liquidity in an inflation swap market is highly concentrated around full year maturities. This means that breakeven swap rates necessary for pricing of inflation swaps in mid-year cannot be observed directly and must be determined from seasonal factors.

In some embodiments, indices described herein can be provided in a customizable report which includes such fields as: index return, price, duration, projected inflation index at index maturity, reference inflation index, nominal yield, nominal discount factors, breakeven inflation rate, real yield, and/or other fields.

Some characteristics of zero-coupon nominal and inflation swap indices, as described herein, include the following: representing a broad set of precise, specific maturities which may not always be available in the cash market, pricing in agreement with the swap market and therefore consistent with the implementation of liquid unfunded strategies, providing pure interest rate exposure without being exposed to bond-specific factors like variations in issuer or bond-specific spread, providing inflation exposure with returns that reflect a realized inflation and changes in inflation expectations, and being discounted at the prevailing nominal interest rates. Other unique characteristics of indices may also be provided.

Applications of zero-coupon nominal and inflation swap indices include: assembling customized benchmarks for liability-driven mandates for open funds by using standard indices which roll every month-end and maintain a stable risk profile and for closed funds—use fixed maturity indices which age as liabilities amortize over time, providing reference indices in risk analysis and attribution, providing analysis tools for asset allocation, providing a synthetic proxy for hedging exposure to synthetic asset portfolios, such as synthetic proxy for inflation-linked bond portfolios, reference indices for funded or unfunded investment products such as total return swaps and index forwards which allow investors to neutralize rate and inflation exposure of liabilities in an unfunded manner, or other applications.

It will be appreciated that the present invention has been described by way of example only, and that the invention is not to be limited by the specific embodiments described herein. Improvements and modifications may be made to the invention without departing from the scope or spirit thereof.

1-30. (canceled)

31. A non-transitory computer-readable storage medium having computer executable instructions recorded thereon that when executed on a computer, configure the computer to perform a method comprising:
accessing data regarding a portfolio comprising an investment in a zero-coupon inflation swap associated with a maturity date, an investment in a zero-coupon nominal swap associated with the maturity date, and a cash investment at a reference rate, wherein a periodic payment on the cash investment at the reference rate is exchanged for a single fixed cash flow at the maturity date, the single fixed cash flow is exchanged for an inflation-indexed cash flow at the maturity date, and an amount of the cash investment at the reference rate relates to a floating leg of the zero-coupon nominal swap;
determining a price of the cash investment using a swap curve;
determining a total return of the portfolio based on the price of the cash investment and a marked-to-market calculation of the zero-coupon inflation swap and the zero-coupon nominal swap, and
generating an index based on the portfolio, wherein a total return of the index relates to a return of a zero-coupon inflation bond at the maturity date, the zero-coupon inflation bond having a price based on the zero-coupon inflation swap and the zero-coupon nominal swap.

32. The non-transitory computer-readable storage medium of claim 31 wherein the portfolio generates a return of a zero-coupon inflation bond priced according to an inflation swap curve.

33. The non-transitory computer-readable storage medium of claim 31 wherein the reference rate comprises LIBOR.

34. The non-transitory computer-readable storage medium of claim 31 wherein a fixed leg of the zero-coupon inflation swap equals: F=(1+b)^{T}, wherein b is a breakeven inflation rate compounded to a maturity T.

35. The non-transitory computer-readable storage medium of claim 34 wherein the method further comprises applying one or more seasonal factors to the breakeven inflation rate.

36. The non-transitory computer-readable storage medium of claim 31 wherein the total return, R, of the index is calculated using the formula:
$$\begin{matrix}R = \frac{P ( t )}{P ( 0 )} - 1 \\ = \frac{I ( t )}{I ( 0 )} \times \frac{{D}_{r} ( t , T )}{{D}_{r} ( 0 , T )} - 1 \\ = \frac{I ( t )}{I ( 0 )} \times \frac{{( 1 + {b}_{t , T} )}^{T - 1}}{{( 1 + {b}_{0 , T} )}^{T}} \times \frac{{( 1 + {n}_{0 , T} )}^{T}}{{( 1 + {n}_{t , T} )}^{T - 1}} - 1.\end{matrix}$$
wherein P(t) is a present value of a future single inflation-indexed cash flow at a time period t,
wherein P(0) is a present value of a future single inflation-indexed cash flow at a time of said investment,
wherein I(t) is a value of the index at time period t,
wherein I(0) is a value of the index at the time of said investment,
wherein Dᵣ(t,T) is a real discount factor at time period t,
wherein Dᵣ(0,T) is a real discount factor at the time of said investment,
wherein b_{t,T} is a breakeven rate to maturity at time period t,
wherein b_{0,T} is a breakeven rate to maturity at the time of said investment,
wherein n_{t,T} is a nominal rate at time period t,
wherein n_{0,T} is a nominal rate at the time of said investment, and
wherein T is a time to said maturity date.

37. The non-transitory computer-readable storage medium of claim 31 wherein the method further comprises:
rebalancing the portfolio at an end date of a period; and
extending the maturity date by the period.

38. The non-transitory computer-readable storage medium of claim 31 wherein the portfolio is static and the maturity date decreases through time.

39. A system for administering an index, comprising:
memory operable to store at least one program; and
at least one processor communicatively coupled to the memory, in which the at least one program, when executed by the at least one processor, causes the at least one processor to:
access data regarding a portfolio comprising an investment in a zero-coupon inflation swap associated with a maturity date, an investment in a zero-coupon nominal swap associated with the maturity date, and a cash investment at a reference rate, wherein a periodic payment on the cash investment at the reference rate is exchanged for a single fixed cash flow at the maturity date, the single fixed cash flow is exchanged for an inflation-indexed cash flow at the maturity date, and an amount of the cash investment at the reference rate relates to a floating leg of the zero-coupon nominal swap;
determine a price of the portfolio using a swap curve;
determine a total return of the portfolio based on a price of the cash investment and a marked-to-market calculation of the zero-coupon inflation swap and the zero-coupon nominal swap, and
generate an index based on the portfolio, wherein a total return of the index relates to a return of a zero-coupon inflation bond at the maturity date, and a price of the zero-coupon inflation bond is based on the zero-coupon inflation swap and the zero-coupon nominal swap.

40. The system of claim 39 wherein the portfolio generates a return of a zero-coupon inflation bond priced according to an inflation swap curve.

41. The system of claim 39 wherein the reference rate comprises LIBOR.

42. The system of claim 39 wherein a fixed leg of the zero-coupon inflation swap equals: F=(1+b)^{T}, wherein b is a breakeven inflation rate compounded to a maturity T.

43. The system of claim 42 wherein the processor is further caused to apply one or more seasonal factors to the breakeven inflation rate.

44. The system of claim 39, wherein the processor is further caused to calculate the total return, R, of the index using the formula:
$$\begin{matrix}R = \frac{P ( t )}{P ( 0 )} - 1 \\ = \frac{I ( t )}{I ( 0 )} \times \frac{{D}_{r} ( t , T )}{{D}_{r} ( 0 , T )} - 1 \\ = \frac{I ( t )}{I ( 0 )} \times \frac{{( 1 + {b}_{t , T} )}^{T - 1}}{{( 1 + {b}_{0 , T} )}^{T}} \times \frac{{( 1 + {n}_{0 , T} )}^{T}}{{( 1 + {n}_{t , T} )}^{T - 1}} - 1.\end{matrix}$$
wherein P(t) is a present value of a future single inflation-indexed cash flow at a time period t,
wherein P(0) is a present value of a future single inflation-indexed cash flow at a time of said investment,
wherein I(t) is a value of the index at time period t,
wherein I(0) is a value of the index at the time of said investment,
wherein Dᵣ(t,T) is a real discount factor at time period t,
wherein Dᵣ(0,T) is a real discount factor at the time of said investment,
wherein b_{t,T} is a breakeven rate to maturity at time period t,
wherein b_{0,T} is a breakeven rate to maturity at the time of said investment,
wherein n_{t,T} is a nominal rate at time period t,
wherein n_{0,T} is a nominal rate at the time of said investment, and
wherein T is a time to said maturity date.

45. The system of claim 39, wherein the processor is further caused to rebalance the portfolio at an end date of a period and to extend the maturity date by the period.

46. The system of claim 39 wherein the portfolio is static and the maturity date decreases through time.
